(19) United States
(12) Patent Application Publication
(10) Pub. No.: US 2009/0021969 A1
(43) Pub. Date: Jan. 22, 2009

(54) APPLIANCE AND POWER SUPPLY THEREFOR

(76) Inventors: Richard George Arthur Butler, Maori Hill (NZ); Benjamin Jay Stewart, Wakari (NZ)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 12/175,798

(22) Filed: Jul. 18, 2008

Related U.S. Application Data
(60) Provisional application No. 60/950,946, filed on Jul. 20, 2007.

(51) Int. Cl. H02M 7/00; H02M 7/06

(52) U.S. Cl. 363/126; 363/125

(57) ABSTRACT

A power supply having an input, a rectifier, a voltage dropping resistor coupled in the circuit to provide a voltage drop between the input and an output of the power supply, a smoothing circuit having at least two capacitors to stabilise the output voltage, whereby a switching network switches the capacitors between a first configuration with a first effective voltage rating, and a second configuration with a second effective voltage rating.

### FIELD OF THE INVENTION

This invention broadly relates to appliances and to power supplies, and in to power supplies for whiteware appliances.

### BACKGROUND TO THE INVENTION

Modern whiteware appliances commonly use switch mode power supplies to supply motor power to motors, solenoids and control electronics. Such power supplies consume power even when on standby (a condition the user considers as being switched off). Further, switch-mode power supplies require the use of relatively expensive components such as inductors and capacitors that have a high working voltage.

In such whiteware appliances it is common to control motor torque and speed using pulse width modulation (PWM) techniques to control current supply to the motor windings. Such PWM circuits also require relatively expensive components.

U.S. Pat. No. 6,469,920 describes a power supply that has gone some way to addressing these problems, the content of which is hereby incorporated by reference.

### SUMMARY OF THE INVENTION

It is an object of the present invention to provide a power supply which goes at least some way towards improving known power supplies, or provide the public with a useful choice.

Briefly, and in accordance with the forgoing, a controlled output voltage DC power supply is provided and is particularly suited for use in whiteware applications, particularly those with built in water heating elements. The power supply includes a rectifier, a variable capacitance, a voltage dropping resistor and a microprocessor.

In use, the rectifier receives AC from a mains supply. The current flow from the output of the rectifier is connected to the variable capacitance to maintain a substantially constant voltage across a load. The variable capacitance is formed by actively switching the configuration of a plurality of capacitors. The voltage dropping resistor is connected in the circuit to reduce the peak unidirectional voltage provided from the rectifier.

A microprocessor controls the timing of the switching, or conducting angle of the switching devices to vary the DC voltage across the variable capacitance to produce a desired output voltage.

The present invention may broadly be said to consist in a DC power supply for use in a washing appliance, said power supply comprising or including:

a rectifier coupled directly or indirectly to the input for receiving and rectifying an AC voltage,

a voltage dropping resistor for heating a fluid, the voltage dropping resistor coupled in the circuit to provide a voltage drop between the input and an output of the power supply, and

a smoothing circuit coupled to receive the rectified AC voltage and provide an output voltage, the smoothing circuit comprising:

at least two capacitors to stabilise the output voltage, and

a switching network to switch the capacitors between a first configuration with a first effective voltage rating, and a second configuration with a second effective voltage rating.

Preferably the first configuration is a series configuration and the second configuration is a parallel configuration.

Preferably the switching network switches the smoothing circuit into a first configuration when the capacitors are charging

Preferably the switching network switches the smoothing circuit into a second configuration when the capacitors are discharging

Preferably the second configuration provides increased capacitance across the power supply output

Preferably wherein the first configuration provides increased voltage tolerance of the smoothing circuit

Preferably the first effective voltage rating is at least the peak voltage of the rectified AC voltage.

Preferably the second effective voltage rating is at least the peak voltage required at the power supply output.

Preferably said smoothing circuit is provided by:

a first capacitor connected in series from a second node to said switch at a first node,

a first diode connected in series between said second node and a third node, said first diode polarised to conduct current from said second node to said third node,

a second switch connected in series between said first node and said third node,

a second diode connected in series between a second rectifier output and said second node, said second diode polarised to conduct current from said second rectifier output to said second node,

a second capacitor connected between said second rectifier output and said third node.

Preferably one or both of said first and second diodes is a semiconductor switching device.

Preferably wherein the switching network includes a controller connected to control at least two switches.

Preferably said controller is a microprocessor.

Preferably said controller is a discrete logic circuit.

Preferably said controller is an analogue circuit.

Preferably wherein said switching devices are semiconductor switching devices.

In another aspect the invention is said to consist in an appliance having a fluid heating element, said appliance comprising or including:

a power supply having an input for coupling to an AC voltage,

a rectifier coupled directly or indirectly to the input for receiving and rectifying an AC voltage,

a voltage dropping resistor that forms the fluid heating element, the voltage dropping resistor coupled in the circuit to provide a voltage drop between the input and an output of the power supply, and

a smoothing circuit coupled to receive the rectified AC voltage and provide an output voltage, the smoothing circuit comprising:

at least two capacitors to stabilise the output voltage, and

a switching network to switch the capacitors between a first configuration with a first effective voltage rating, and a second configuration with a second effective voltage rating.

Preferably the first configuration is a series configuration and the second configuration is a parallel configuration.

Preferably the switching network switches the smoothing circuit into a first configuration when the capacitors are charging

Preferably the switching network switches the smoothing circuit into a second configuration when the capacitors are discharging

Preferably the second configuration provides increased capacitance across the power supply output

Preferably the first configuration provides increased voltage tolerance of the smoothing circuit

Preferably the first effective voltage rating is at least the peak voltage of the rectified AC voltage.

Preferably the second effective voltage rating is at least the peak voltage required at the power supply output.

Preferably said smoothing circuit is provided by:

a first capacitor connected in series from a second node to said switch at a first node,

a first diode connected in series between said second node and a third node, said first diode polarised to conduct current from said second node to said third node,

a second switch connected in series between said first node and said third node,

a second diode connected in series between a second rectifier output and said second node, said second diode polarised to conduct current from said second rectifier output to said second node,

a second capacitor connected between said second rectifier output and said third node.

Preferably one or both of said first and second diodes is a semiconductor switching device.

Preferably the switching network includes a controller connected to control at least two switches.

Preferably said controller is a microprocessor.

Preferably said controller is a discrete logic circuit.

Preferably said controller is an analogue circuit.

Preferably said switching devices are semiconductor switching devices.

In another aspect the invention is said to consist in a DC power supply generating an output voltage from an AC mains supply, said power supply comprising or including:

a rectifier, adapted for coupling to an AC mains supply,

a voltage dropping resistor,

a first and a second capacitor, and

a first and a second switching device,

wherein said first and second capacitors charge in a series circuit arrangement and discharge in a parallel circuit arrangement to provide said output voltage, and said voltage dropping resistor is connected in series with at least the charging circuit arrangement.

In another aspect the invention is said to consist in a DC power supply generating an output voltage from an AC mains supply, said power supply comprising or including:

a rectifier, which receives AC from a mains supply,

a voltage dropping resistor, and

a switch connected in series between said rectifier and a variable capacitance

wherein said switch controllably allows current to flow from the output of said rectifier to said variable capacitance to provide said controlled output voltage.

Preferably said variable capacitance is provided by a first and a second capacitor.

Preferably said first and second capacitor charge in series, and said first and second capacitor discharge in parallel.

Preferably said variable capacitance is provided by:

a first capacitor connected in series from a second node to said switch at a first node,

a first diode connected in series between said second node and a third node, said first diode polarised to conduct current from said second node to said third node,

a second switch connected in series between said first node and said third node,

a second diode connected in series between a second rectifier output and said second node, said second diode polarised to conduct current from said second rectifier output to said second node,

a second capacitor connected between said second rectifier output and said third node.

Preferably said first and second capacitor charge in series, and said first and second capacitor discharge in parallel.

Preferably one or both of said first and second diodes is a semiconductor switching device.

In another aspect the invention is said to consist in an appliance having a heating element and a power supply, said appliance comprising or including:

a rectifier, which receives AC from said mains supply,

a first and a second capacitor, and

a first and a second switch,

wherein said heating element is a voltage dropping resistor and reduces the peak unidirectional voltage from the rectifier.

In another aspect the invention is said to consist in a DC power supply generating a controlled output voltage, said power supply comprising or including:

a rectifier, which receives AC from a mains supply,

a voltage dropping resistor connected in series with said rectifier,

a first switch connected between a first rectifier output and a first node,

a first capacitor connected between said first node and a second node,

a first diode connected between said second node and a third node, and polarised to conduct current from said second node to said third node,

a second switch connected between said first node and said third node,

a second diode connected between a second rectifier output and said second node, and polarised to conduct current from said second rectifier output to said second node,

a second capacitor connected between said second rectifier output and said third node, said second capacitor providing said controlled output voltage output,

and a controller for variably controlling the conduction of said first and said second switch relative to the phase of said mains supply.

Preferably one or both of said first and second diodes is a semiconductor switching device.

In another aspect the invention is said to consist in a DC power supply generating a controlled output voltage, said power supply comprising or including:

a rectifier, which receives AC from a mains supply,

a voltage dropping resistor connected in series with said rectifier,

a first and a second diode,

a first and a second capacitor,

a switch,

said first and second capacitor charging in series,

said second diode conducting when said second switch is not conducting to connect said capacitors in series,

said first diode conducting when said switch is conducting to connect said capacitors in parallel,

said first and second capacitor discharging in parallel when said switch is conducting to provide said controlled output voltage,

and a controller for variably controlling the conduction of said switch relative to the phase of said mains supply.

Preferably one or both of said first and second diodes is a semiconductor switching device.

Preferably said voltage dropping resistor is connected in series with the input of said rectifier.

Preferably said voltage dropping resistor is connected in series with the output of said rectifier.

Preferably said power supply supplies power to a motor in a home appliance which uses hot water and said voltage dropping resistor is a heating element for heating said water.

Preferably said controller is a microprocessor.

Preferably said controller is a discrete logic circuit.

Preferably said controller is an analogue circuit.

### BRIEF DESCRIPTION OF THE DRAWINGS

The invention will now be described with reference to the following figures.

FIG. 1 is a simplified circuit diagram of the DC power supply of the present invention.

FIGS. 2a to 2d are ideal waveform diagrams of the voltage or current through various components of the power supply.

FIGS. 3a to 3d illustrate simulated real voltages and current waveform at various places in the power supply circuit.

### DETAILED DESCRIPTION

The power supply of the present invention is particularly suited for use in whiteware appliances that have built-in heater elements, for example, dishwashers and washing machines. Preferred embodiments of the power supply will now be described.

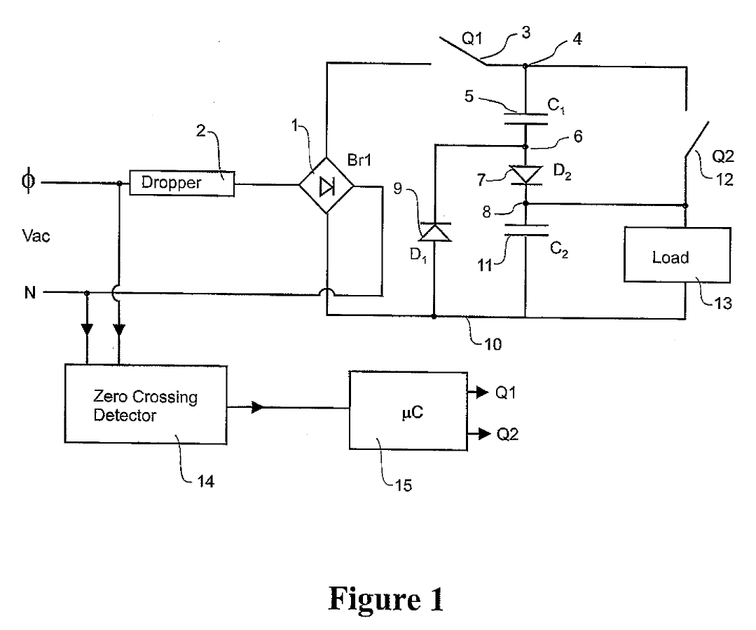

A simplified circuit diagram of the power supply of the present invention is shown in FIG. 1. The preferred power supply is transformerless in design and uses a high power voltage dropping resistor 2 and phase switched control of rectified mains voltage waveforms to produce a direct current rail. The rail voltage is variable from a very low voltage up to approximately the voltage of the mains supply.

The variable voltage output may be used to control an appliance motor or appliance control circuitry, and the voltage dropping resistor 2, which dissipates significant power, forms a water heating element.

The use of a power dissipating voltage dropping resistor would be considered unacceptable for many power supply applications as it dissipates significant amounts of energy. However, the power dissipated from such a resistor can be put to good use as a heating element in whiteware appliances that require a heater. For example, the heater can be used to produce hot water or wash fluids. Alternatively the dropper resistor may be used to heat any other kind of gas, solid or liquid in an appropriate application. Therefore, this normally disadvantageous circuit feature becomes an advantage.

Referring to FIG. 1, an AC mains supply is connected to a rectifier 1. The rectifier 1 may be a full wave rectifier such as a bridge rectifier. Connected between the main supply and the bridge rectifier 1 is the dropper resistor 2.

The maximum DC voltage to be supplied by a power supply is limited to the maximum voltage of the mains supply. However, the required voltage is typically lower. The value of the voltage dropping resistor 2 will differ depending on the nominal mains voltage. For example, if the appliance is connected to a 50 Hz, 230 volt mains supply and an output of 85 volts with a maximum current supply of 1 Amp is desired, the required value of voltage dropping resistor 2 is 129 ohms. Therefore, the range of required output voltages from the power supply determines the value of the dropper resistor 2.

A first switch 3 is connected to the rectified and dropped mains supply. The first switch 3 serially connects the supply to a first node 4. A first capacitor 5 serially connects the first node 4 to a second node 6. A first diode 7 serially connects the second node 6 to a third node 8. The diode 7 is polarised to allow current flow from the second node 6 to the third node 8. A second diode 9 is serially connected between the circuit ground 10 and the second node 6. The second diode 9 is polarised to allow current flow from the first ground plane 10 to the second node 6. A second capacitor 11 is serially connected between the third node 8 and the ground plane 10. A second switch 12 is serially connected between the first node 4 and the third node 8.

The first and second switches are ideally semiconductor switching devices such as a transistor, but may be any other switching device that connects two electrical nodes together, and is controllable by an electrical signal.

Persons skilled in the art will appreciate that the dropper resistor 2 may be alternatively placed elsewhere in the circuit with appropriate modifications to the voltage ratings of components that precede it. For example, the dropper resistor may he placed in several circuit locations such as the phase or neutral side of the rectifier 1, the positive or negative output of the rectifier 1, in series with an individual diode in the rectifier, or in series with the anode or cathode of the first diode 7.

An electrical load 13 provided by the appliance or system where the power supply is installed is connectable between the third node 8 and the electrical ground 10. A controlled voltage output is achievable to load 13 by controlling the switching phase of switches 3, 12 relative to the phase of the mains supply.

A controller 15, herein embodied by a microprocessor, controls phase switching and therefore the output voltage of the power supply. The microprocessor 15 may either directly or indirectly control switches 3, 12. The microprocessor is preferably the same device that forms the appliance controller. Preferably the microprocessor has a reference to the phase of the mains supply. In the preferred form of the invention a zero crossing detector circuit 14 detects when the mains supply crosses zero volts.

The zero crossing detector 14 is connected to the mains supply input to the power supply circuit. The zero crossing detector 14 produces a timing signal relative the phase of the mains supply. The timing signal output from the zero crossing detector is then supplied to microprocessor 15.

The tasks performed by the microprocessor could equally be implemented by appropriate analogue or discrete logic circuits without departing from the scope of the invention. For example, a discrete oscillator circuit may be synchronised with the mains supply zero crossing to control the switching of the switching devices 3, 12. However, a microprocessor provides the most cost effective and precise solution for the switching control.

The circuit is arranged such that the microprocessor 15 can configure the arrangement of capacitors 5, 11 by controlling the opening and closing the second switch 12. That is, when the second switch 12 is open, the first and second capacitors 5, 11 are connected in series by virtue of diode 7 conducting. When the second switch 12 is closed, the first and second capacitors are connected in parallel by virtue of diode 9 conducting.

The capacitors 5, 11 in both the series and parallel configuration form a smoothing circuit or filter for the rectified AC voltage. The smoothing circuit is used to reduce the ripple voltage of the rectified AC voltage and stabilise the output of the power supply.

Advantageous properties of series and parallel capacitor arrangements are exploited by actively switching their configuration. In the preferred embodiment of the invention the switching of the first and second switches is controlled relative to the phase of the mains supply such that the capacitors 5, 11 charge in series and discharge in parallel.

A greater voltage potential can be applied across a series capacitor combination compared to capacitors in a parallel configuration. Therefore, a higher voltage portion of the mains waveform can be used to charge the capacitors. Alternatively, capacitors with a lower voltage rating can be used for series configured capacitors. Capacitors in series therefore provide an economical way of obtaining a higher voltage capacitor that would otherwise be required to withstand a given applied voltage from the supply.

In addition, the total capacitance is increased when the capacitors 5, 11 are switched into a parallel configuration. This provides an economical way of increasing the total capacitance used to smooth the rectified mains supply, therefore further decreasing the ripple voltage and maintaining stability of the voltage output from the power supply.

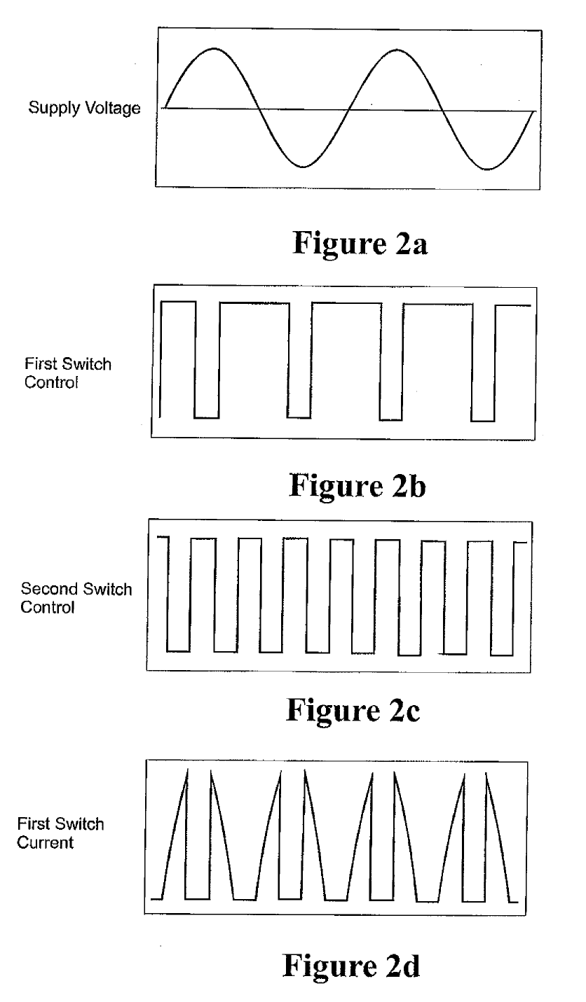

Referring generally to FIGS. 2a to 2d, shown is a typical mains supply voltage waveform, a control signal to the first switch 3 from the microprocessor 15, a control signal to the second switch 12 from the microprocessor 15 and a waveform of the resulting current that flows through the first switch 3.

The first switch 3 allows current from the mains power source to flow through the dropper resistor 2 to the remainder of the circuit. In these figures, a switch is conducting when a control signal is high.

During the first positive going portion of the rectified mains supply, assuming two substantially identical capacitors are used, the capacitors are charged in series until the mains supply reaches a voltage approximately twice the desired output voltage. The voltage supplied to the load will then be the voltage divided between both capacitors as the load 13 is connected across the second capacitor 11.

The capacitors are then switched into a parallel configuration. The parallel configuration provides an increase in total capacitance and a decrease in total voltage potential. The parallel configuration of the first and second capacitors 5, 11 provide a voltage across the load substantially equal to the series configuration. However, the benefits of extra capacitance are provided. The capacitors are therefore switched into their most advantageous configuration depending on the level of the voltage from the mains supply.

The first switch 3 disconnects during the peak portion of the rectified mains supply. By disconnecting over this portion of the mains supply a lower voltage tolerance is required for the remainder of the circuit components.

The lower total voltage tolerance required provides that more economical circuit components can be used. A further advantage of a lower peak voltage is that dropper resistor 2 conducts for a reduced portion of the mains supply cycle. It is therefore possible for the resistor to dissipate less energy compared to known power supplies of this type.

In operation, the microprocessor 15 receives the reference timing signal from the zero crossing detector 14. The microprocessor 15 signals the primary switch 3 to conduct from the zero crossing until a desired peak voltage is reached during the positive going part of the waveform. The desired peak voltage corresponds to the desired voltage at the output of the power supply circuit.

The microprocessor 15 signals the primary switch 3 to disconnect when the desired voltage at the output of the power supply circuit is reached, primary switch 3 is signalled to reconnect when the rectified and dropped mains supply voltage drops again to the desired level during the negative going part of the waveform.

The duty cycle of the control signal supplied by microprocessor 15 to the first switch 3 is be adjusted to maintain, increase or decrease a desired voltage across the load 13 by adjusting the conduction time of the switch 3 around the peak of the rectified and dropped mains supply. The duty cycle is adjusted according to a reference voltage taken from the output of the power supply circuit. That is, the conduction time of the first switch can be increased about the peak of the supply voltage waveform when a higher output voltage is required. Similarly, the conduction time of the first switch can be decreased about the peak of the supply voltage waveform when a lower output voltage is required.

By monitoring the output of the power supply the microprocessor 15 can actively adjust the conduction time of the first switch to maintain a substantially constant load voltage under fluctuating power demands from the load. FIG. 2b illustrates an example of the signal waveform supplied to the first switch 3 with reference to the phase of the mains supply as shown in FIG. 2a.

Microprocessor 15 signals the second switch 12 to connect to configure the first and second capacitors 5, 11 in parallel, or disconnect and configure them in series. The capacitors are configured in series when the first switch 3 is conducting. This allows the capacitors to charge in series. The microprocessor signals the second switch 2 to connect, and therefore configure the first and second capacitors in parallel when the first switch 3 is signalled to disconnect. While the first switch 3 is disconnected, the parallel capacitor configuration provides increased capacitance, and therefore increased supply stability across the load. The microprocessor 15 signals the second switch 12 to disconnect when the rectified and dropped negative going mains supply falls below the upper desired voltage limit.

The microprocessor 15 signals the second switch 12 to reconnect for the period where the rectified and dropped mains supply falls below the voltage potential of the capacitors 5, 11. The capacitors have a greater voltage potential than the rectified and dropped mains supply during this period of the supply cycle. The bridge rectifier is therefore insulating during this period of the supply cycle and further charging of the capacitors will not occur. When the second switch 12 reconnects the capacitors are configured in parallel again and the desired output of the power supply is maintained. FIG. 2c illustrates an example of the signal waveform supplied to the second switch 12 with reference to the phase of the mains supply as shown in FIG. 2a.

Preferably the capacitors 5, 11 charge when in a series configuration and when the voltage potential of the rectified and dropped mains supply is high enough. FIG. 2d illustrates the periods where charging occurs with reference to the mains supply as shown in FIG. 2a.

A separation time of 60 ms between switching each switch provides a safety margin to ensure device rise and fall times of each switching device do not overlap. This may be especially applicable when each switch is a semiconductor switching device having a limited operation speed.

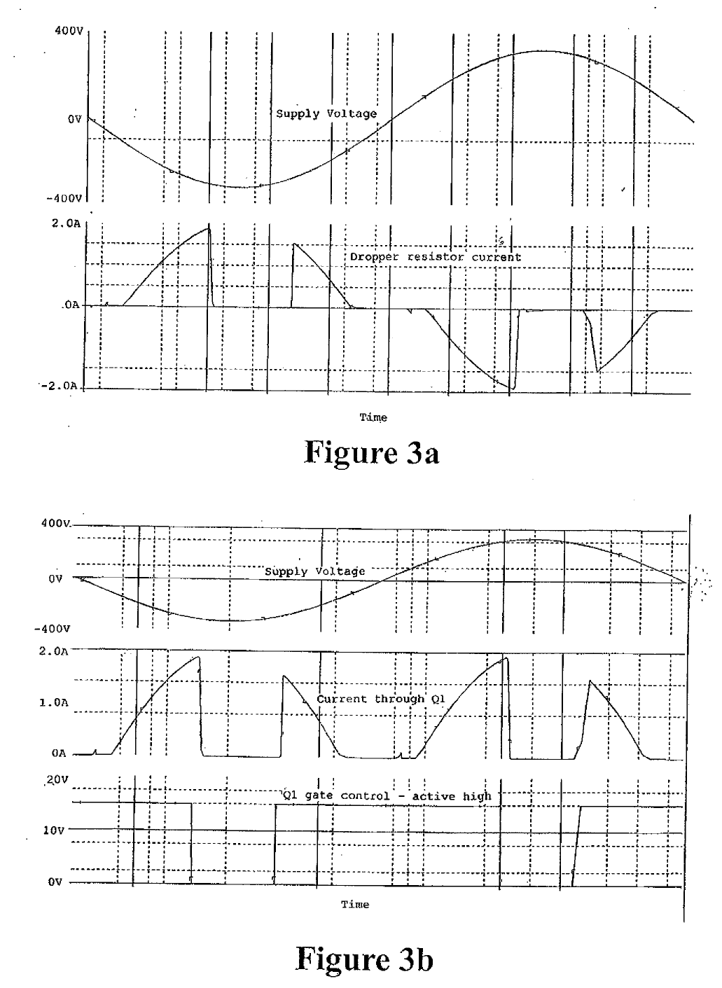

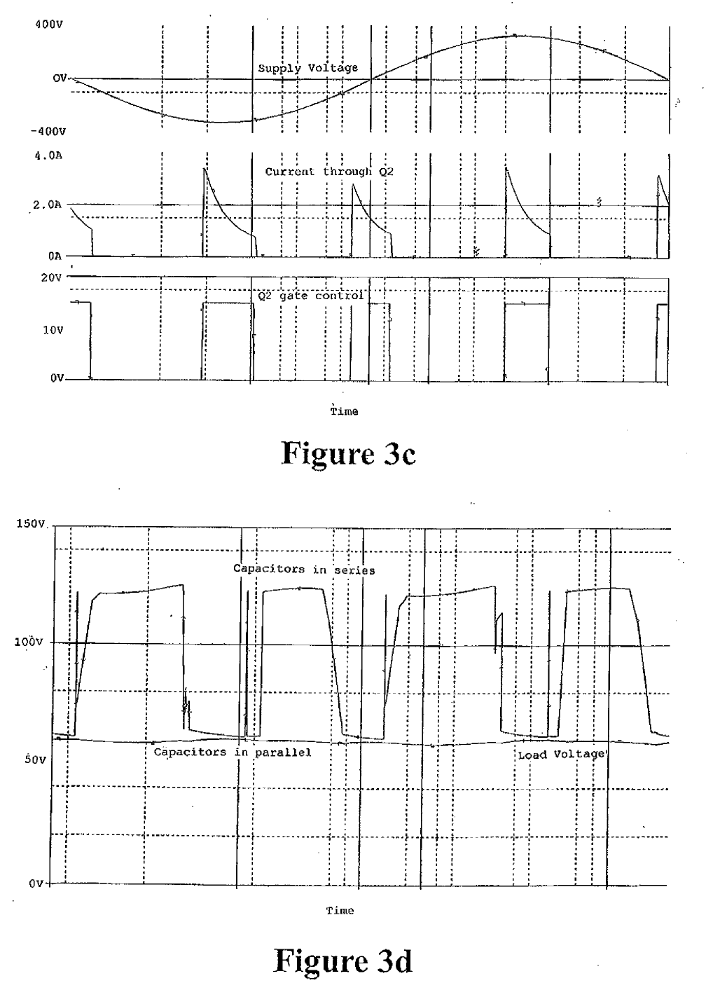

FIGS. 3a to d show simulated waveform diagrams of currents and voltages for various circuit components using the above described control strategy. FIG. 3a illustrates the current draw through the dropper resistor with reference to the mains supply phase. FIG. 3b illustrates the control signal to the first switch and the resulting current that flows through it with reference to the mains supply phase. FIG. 3c illustrates the control signal to the second switch and the resulting current that flows through it with reference to the mains supply signal. FIG. 3d illustrates the voltage across the capacitors when in a series configuration, and in a parallel configuration, and the resulting stabilised voltage output from the power supply.

Therefore there is provided a power supply that maintains a substantially constant and controllable voltage across a load.

Those skilled in the art will appreciate that the particular instance the configuration of the first and second capacitors is switched, with respect to the phase of the mains supply, can be altered without departing from the scope of the invention. However, the method described above is believed to the most power efficient.

It is possible for the control signals to the first and second switches to be altered such that a stable power supply output is maintained while still taking advantage of the series and parallel capacitor configurations.

An example of an alternative control strategy is holding the first switch 3 closed for the majority of the rectified AC wave cycle as described in U.S. Pat. No. 6,469,920. The second switch 12 is then only closed when the rectifier 1 is insulating. While this control strategy would provide a stable supply output, the power dissipated in the dropper resistor would be higher, and the second switch 12 would need to be a more robust and expensive device.

Another alternative strategy may be that the capacitors are switched into a parallel configuration when the voltage input to the smoothing circuit is below the voltage rating of the parallel capacitor configuration, and subsequently switched into a series capacitor configuration when the voltage input to the smoothing circuit is above the voltage rating of the parallel capacitor configuration.

The power supply of the present invention provides a number of advantages in applications where the power dissipated by the voltage dropping resistor 2 can be put to good use. Such advantages include the absence of inductors, the avoidance of the need of a PWM circuit for motor control, a low voltage rating for either or both of the first and second capacitors 3, 12, reduced radio frequency interference, and reduced power consumption when the appliance is on stand-by.

Another advantage this power supply provides over the prior art power supply described in U.S. Pat. No. 6,469,920 is the current drawn through the dropper resistor is halved. Therefore the power dissipated in the dropper resistor is reduced by 75% during the standby operation of the appliance.

The first and second capacitors 5, 11 may have an unequal voltage potential between them when in a series configuration. The unequal voltage potential may arise due to the second capacitor 11 being drained by the load 13. A surge of current will occur to equalise the voltage potential between each capacitor when they are switched into a parallel configuration. Second switch 12 should therefore be rated at a current high enough to handle the surge. The second switch 12 may be ramped to full conduction gradually to minimise current surge.

A further advantage of the present invention is the ratio between a fault current and the operating current of the circuit is increased. This permits reliable fusing of the power supply.

In conjunction with the reduction of power when on standby the present circuit has the advantage over conventional switch mode controlled power supplies in that it is unnecessary to use a separate standby power supply.

In most appliances one or more fixed voltage DC power supplies will also be required and these can be derived from the present variable voltage DC power supply by use of pulse modulators to provide voltages at values such as 5 volts and 24 volts.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

What we claim is:

1. A power supply having an input for coupling to an AC voltage,
a rectifier coupled to the input for receiving and rectifying an AC voltage,
a voltage dropping resistor coupled in the circuit to provide a voltage drop between the input and an output of the power supply, and
a smoothing circuit coupled to receive the rectified AC voltage and provide a stabilized output voltage, the smoothing circuit comprising:
at least two capacitors, and
a switching network to switch the capacitors between a first configuration with a first effective voltage rating, and a second configuration with a second effective voltage rating.

2. A power supply as claimed in claim 1, wherein the switching network switches the smoothing circuit into a first configuration whereby said capacitors are chargeable in a series arrangement.

3. A power supply as claimed in claim 1, wherein the switching network switches the smoothing circuit into a second configuration whereby said capacitors are dischargeable in a parallel arrangement.

4. A DC power supply as claimed in claim 1, wherein said smoothing circuit is provided by:
a first switch connected between the output of the rectifier at a first node and to a second node,
a first capacitor connected between the second node and a third node,
a first diode having the anode connected to the third node and the cathode connected to a fourth node,
a second capacitor connected between the fourth node and a fifth node,
a fifth node connecting to the 0 V output of the rectifier,
a second diode having the anode connected to the fifth node and the cathode connected to the third node,
a second switch connected between the second node and the fourth node,
wherein an electrical load is connectable between the fourth and fifth nodes.

5. A power supply as claimed in claim 4, wherein one or both of said first and second diodes is a semiconductor switching device.

6. A power supply as claimed in claim 4, wherein the switching network includes a controller connected to control the first and second switch.

7. A power supply as claimed in claim 1, wherein said power supply is for use in a whiteware appliance.

8. A power supply as claimed in claim 1, wherein said voltage dropping resistor is a heating element for a whiteware appliance.

9. A power supply as claimed in claim 6 wherein said controller is operable to variably control the conduction of said first and second switches relative to the phase of the AC voltage.

10. An appliance having a fluid heating element,
a power supply having an input for coupling to an AC voltage,
a rectifier coupled directly or indirectly to the input for receiving and rectifying an AC voltage,
a voltage dropping resistor that forms the fluid heating element, the voltage dropping resistor coupled in the circuit to provide a voltage drop between the input and an output of the power supply, and
a smoothing circuit coupled to receive the rectified AC voltage and provide an output voltage, the smoothing circuit comprising:
at least two capacitors to stabilise the output voltage, and
a switching network to switch the capacitors between a first configuration with a first effective voltage rating, and a second configuration with a second effective voltage rating.

11. A power supply generating a DC output voltage from an AC mains supply,
a rectifier, adapted for coupling to an AC mains supply,
a voltage dropping resistor,
a first and a second capacitor, and
a first and a second switching device,
wherein said first and second capacitor charge in a series circuit arrangement and discharge in a parallel circuit arrangement to provide said output voltage, and said voltage dropping resistor is connected in series with at least the charging circuit arrangement.

12. A power supply as claimed in claim 11, wherein said power supply is for use in a whiteware appliance.

13. A power supply as claimed in claim 11, wherein said voltage dropping resistor is a heating element for a whiteware appliance.

14. A power supply as claimed in claim 11 further comprising a controller, said controller operable to variably control the conduction of said first and second switches relative to the phase of said AC voltage.

15. A DC power supply generating a controlled output voltage,
a rectifier, which receives AC from a mains supply,
a voltage dropping resistor, and
a switch connected in series between said rectifier and a variable capacitance
wherein said switch controllably allows current to flow from the output of said rectifier to said variable capacitance to provide said controlled output voltage.

16. A DC power supply as claimed in claim 15, wherein said variable capacitance is provided by
a first and a second capacitor, and said first and second capacitor charge in series, and discharge in parallel.

17. A DC power supply as claimed in claim 15, wherein said variable capacitance is provided by:
a first switch connected between the output of the rectifier at a first node and to a second node,
a first capacitor connected between a second node and a third node,
a first diode having the anode connected to said third node and the cathode connected to a fourth node,
a second capacitor connected between said fourth node and a fifth node,
a fifth node connecting to the 0 V output of the rectifier,
a second diode having the anode connected to said fifth node and the cathode connected to said third node,
a second switch connected between said second node and said fourth node,
wherein an electrical load is connectable between said fourth and fifth nodes.

18. A DC power supply as claimed in claim 15, wherein said power supply is for use in a whiteware appliance.

19. A DC power supply as claimed in claim 15, wherein said voltage dropping resistor is a heating element for a whiteware appliance.

20. A DC power supply as claimed in claim 15 further comprising a controller, said controller operable to variably control the conduction of said switch relative to the phase of said AC voltage.
